(19) United States
(12) Patent Application Publication
(10) Pub. No.: US 2006/0274899 A1
(43) Pub. Date: Dec. 7, 2006

(54) System and method for secure messaging with network address translation firewall traversal

(75) Inventors: Yuesheng Zhu, San Jose, CA (US); Chih-Ping Lee, Cupertino, CA (US); Shih-An Cheng, Cupertino, CA (US)

Correspondence Address: TIMOTHY P. O'HAGAN, 8710 KILKENNY CT, FORT MYERS, FL, 33912, US

(73) Assignee: Innomedia Pte Ltd., Singapore (SG)

(21) Appl. No.: 11/145,378

(22) Filed: Jun. 3, 2005

(51) Int. Cl. H04L 9/00

(52) U.S. Cl. 380/281

(57) ABSTRACT

A system for securing communications between a client and an application server comprises a session key management server and the application server. The system enables network address translation firewall traversal. The session key management server comprises a key management application, a session key database, and a notification services application. The key management application receives a first transport layer security connection request from the client and negotiates a device session master key with the client as part of the transport layer security exchange. The session key database is coupled to the key management application for storing the device session master key in conjunction with an identification of the client. The notification services application coupled to the session key database and provides a notification message to subscribing application servers. The notification message comprises the device session master key in conjunction with an identification of the client.

### TECHNICAL FIELD

The present invention relates to secure messaging over an open network and more specifically, to a system and method for securing UDP/IP messaging in an environment with NAPT firewall traversal.

### BACKGROUND OF THE INVENTION

For many years voice telephone service was implemented over a circuit switched network commonly known as the public switched telephone network (PSTN) and controlled by a local telephone service provider. In such systems, the analog electrical signals representing the conversation are transmitted between the two telephone handsets on a dedicated twisted-pair-copper-wire circuit. More specifically, each telephone handset is coupled to a local switching station on a dedicated pair of copper wires known as a subscriber loop. When a telephone call is placed, the circuit is completed by dynamically coupling each subscriber loop to a dedicated pair of copper wires between the two switching stations.

More recently, the copper wires, or trunk lines between switching stations have been replaced with fiber optic cables. A computing device digitizes the analog signals and formats the digitized data into frames such that multiple conversations can be transmitted simultaneously on the same fiber. At the receiving end, a computing device reforms the analog signals for transmission on copper wires. Twisted pair copper wires of the subscriber loop are still used to couple the telephone handset to the local switching station.

More recently yet, voice telephone service has been implemented over the Internet. Advances in the speed of Internet data transmissions and Internet bandwidth have made it possible for telephone conversations to be communicated using the Internet's packet switched architecture.

To promote the wide spread use of Internet telephony, the Internet Engineering Task Force (IETF) has developed the Session Initiation Protocol (SIP) and the Multi-Media Gateway Control Protocol (MGCP) for signaling and establishing a peer-to-peer Voice-over-Internet Protocol (VoIP) media session.

Both SIP and MGCP provide for a VoIP client to exchange messages over UDP/IP channels with various application servers for purposes of managing the client and establishing VoIP media sessions (e.g. VoIP telephone calls).

In an example of using an MGCP system, the application servers may include a call agent, a TFTP server, and an SNMP server. The TFTP server and the SNMP server provide management functions. The all call agent exchanges messages with the VoIP client (commonly referred to as an MGCP gateway) for enabling calls to be placed by (and calls to be placed to) the VoIP client.

For example, to establish a peer-to-peer VoIP media session (e.g. a VoIP telephone call), the calling MGCP gateway initiates the session by sending notify (NTFY) messages to an MGCP call agent which indicate the intended destination of the call. The MGCP call agent sends a sequence of create connection (CRCX) messages and modify connection (MDCX) messages to each of the calling MGCP gateway and the MGCP gateway supporting the destination device such that the two can begin exchanging real time protocol (RTP) media sessions over UDP/IP channels.

One problem associated with Internet telephony systems is that the frame switched architecture of the network introduces a lack of security. The lack of security in call signaling messages and device management messages over UDP/IP channels can lead to one of several results including in-operation of the Internet telephony device or unintended operation of the Internet telephony device with systems of another Internet telephony service provider.

Various systems have been developed under a protocol known as “IPSec” to provide transport layer security. The systems may user the Authentication Header “AH” protocol, the Encapsulating Security Payload “ESP” protocol, or both. The AH protocol and the ESP protocol are described in more detail in ITEF RFC2401-2406. In general, IPSec can be implemented between two endpoints provided there is no firewall there between. However, if one of the endpoints is served by a network address and port translation (NAPT) firewall, IPSec only works if the firewall is configured for IPSec.

Because Internet telephony clients are often deployed on sub-nets (such as home networks, an office network, or even an Internet Service Provider (ISP) network) which are coupled to the Internet by an NAPT firewall, the existing IPSec solutions become impractical for securing UPD/IP messaging for Internet telephony systems. More specifically, in many environments, neither the telephony service provider nor the user of the Internet telephony client has control of the NAPT firewall and therefore is, unable to configure the NAPT firewall for IPSec. Further, even if one of the two has control of the NAPT firewall, IPSec configuration can be cumbersome to manage.

What is needed is a solution that does not suffer the disadvantage of such known security systems. More specifically, what is needed is a security system for securing UDP/IP messaging which not fail to operate if a client is served by an NAPT firewall system.

### SUMMARY OF THE INVENTION

The present invention comprises a system for securing UDP/IP communications between a client (such as an MGCP gateway) and an application server (such as an MGCP call agent) in an environment wherein the client may be coupled to a local area network, assigned a non-globally unique IP address, and served by a network address and port translation (NAPT) firewall.

The system comprises a session key management server and the application server with which the client communicates using UDP/IP messaging. The session key management server and the application server may both operate on the same hardware system—or be on discreet hardware systems communicatively coupled by network systems.

The session key management server comprises a key management application, a session key database, a notification services application, and an encryption engine.

The key management application receives a transport layer security (TLS) connection request from the client. The connection request includes an indication to negotiate a shared secret device session master key as part of a transport layer security exchange. The key management application and the client: i) authenticate to each other; and ii) negotiate a device session master key using TLS extensions and known Diffie-Hellman shared secret key negotiation techniques as part of the TLS exchange. Mutual authentication may be by the exchange of digital certificates or may be though use of pre-shared key techniques. The device session master key is assigned a mutually calculated expiration time.

The session key database is coupled to the session key management application and stores the device session master key in conjunction with its expiration time and an identification of the client.

The key management application further receives a (TLS) connection request from the application server. The connection request includes an indication to negotiate an application session master key as part of a transport layer security exchange. The session key management application and the application server: i) authenticate to each other; and ii) negotiate an application session master key using TLS extensions and known DH shared secret key negotiation techniques as part of the TLS exchange. The application session master key is assigned a mutually calculated expiration time.

The application session master key is used to encrypt the payload of messages exchanged between the notification services application and the application server. The notification services application is coupled to the session key database and provides a notification message (encrypted by the encryption engine using a symmetric encryption algorithm and the application session master key) to a notification client of the application server. The notification message comprises the device session master key and its expiration time in conjunction with an identification of the client.

The application server comprises a session key client, the notification client, a session key database, and an encryption module.

The session key client provides the TLS connection request to the session key management server and negotiates the application session master key with the session key management server.

The notification client subscribes to the notification services application of the session key management server and obtains the notification message (as encrypted payload of a UDP/IP message, the payload being encrypted using the symmetric encryption algorithm and the application session master key) from the notification services application.

The encryption module uses the application session master key to decipher the encrypted payload to recover the notification message. The database is coupled to the notification client and stores the device session master key and its expiration time in conjunction with identification of the client.

The encryption module is further coupled to the database and: i) receives a message from the client (the message including the identification of the client in a message header and encrypted payload); ii) obtains the device session master key associated with the identification of the client from the database; and iii) deciphers the encrypted payload using a symmetric encryption algorithm and the device session master key to generated deciphered payload for delivery to a base UDP/IP application.

The base UDP/IP application (such as an MGCP call agent) receives the deciphered payload and generates a response message for the client. The response message includes response payload and a header. The header includes a destination IP address and port number matching the source IP address and port number of the message header of the message received from the client. This enables the message to be returned even if the client is served by an NAPT firewall.

The encryption module provides for encrypting the response payload of the response message using the symmetric encryption algorithm and the session master key that is associated with the client that is associated with the destination IP address of the response message.

The key management application of the session key management server may further receive a TLS connection request from a second client. This second connection request includes an indication to negotiate a device session master key as part of a transport layer security exchange. The key management application and the second client: i) authenticate to each other; and ii) negotiate a second device session master key using TLS extensions and known DH shared secret key negotiation techniques as part of the TLS exchange. The second device session master key is assigned a mutually calculated expiration time (a second expiration time).

The session key database stores the second device session master key in conjunction with its expiration time and in association with an identification of the second client. The notification message further comprises the second device session master key and its expiration time in association with an identification of the second client.

When the second client provides a message to the application server, the encryption module of the application server: i) receives the message from the second client; ii) obtains the second device session master key associated with the identification of the second client from the database; and iii) deciphers the encrypted payload using a symmetric encryption algorithm and the second device session master key to generated deciphered payload for delivery to a base UDP/IP application.

The base UDP/IP application (such as an MGCP call agent) receives the deciphered payload and generates a response message for the second client. The response message includes response payload and a header. The header includes a destination IP address and port number matching the source IP address and port number of the message header of the message received from the second client. This enables the message to be returned even if the second client is served by an NAPT firewall.

The encryption module provides for encrypting the response payload of the response message using the symmetric encryption algorithm and the second device session master key that is associated with the second client that is associated with the destination IP address of the response message.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWING

FIG. 1 is a block diagram representing a first embodiment of a system for secure messaging over UDP/IP channels;

FIG. 2 is a flow chart representing exemplary operation of a session key client in accordance with one embodiment of the present invention;

FIG. 3a is a ladder diagram representing operation of a session key management server and its interaction a session key client in accordance with one embodiment of the present invention;

FIG. 3b is a ladder diagram representing operation of a session key management server and its interaction a session key client in accordance with an alternative embodiment of the present invention;

FIG. 4 is a flow chart representing exemplary operation of a notification client of an application server in accordance with one embodiment of the present invention;

FIGS. 5a and 5b are flow charts representing exemplary operation of an encryption module of an application server in accordance with one embodiment of the present invention;

FIG. 6a is a block diagram representing an exemplary UDP/IP frame sent to an application server in accordance with one embodiment of the present invention;

FIG. 6b is a block diagram representing an exemplary UDP/IP frame sent by an application server in accordance with one embodiment of the present invention; and

FIG. 7 is a flow chart representing exemplary operation of a notification services server in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

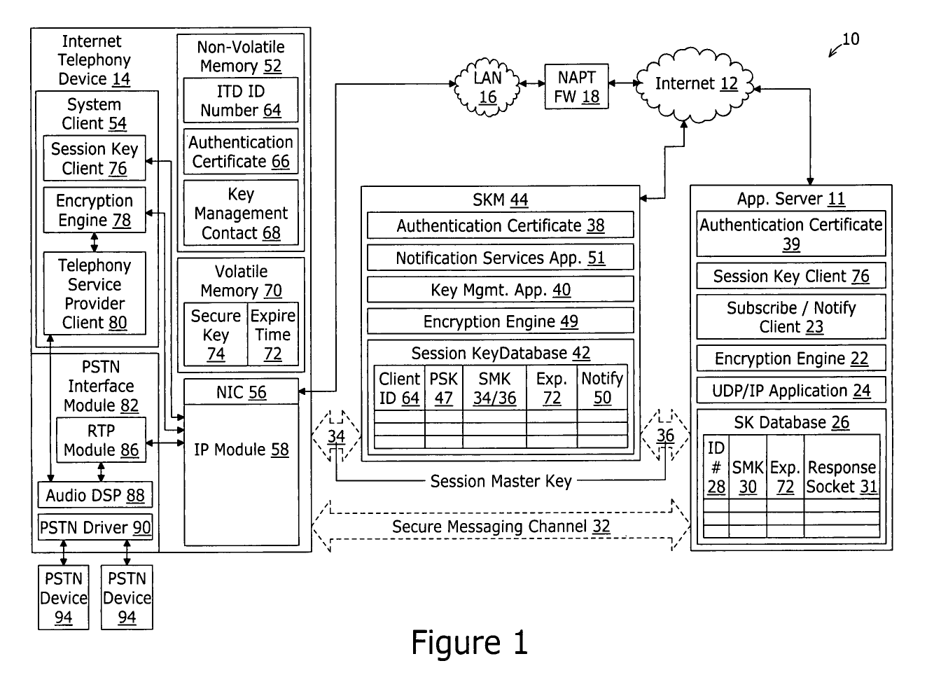

FIG. 1 represents a block diagram of an embodiment of a session key management and messaging system 10 which enables one or more application servers 11 (such as a Multi-Media Gateway Control Protocol (MGCP) Call Agent) of a VoIP service provider's infrastructure to exchange messages over UDP/IP channels with supported Internet telephony devices (Internet telephony devices) 14 in a secure manner and through a network address and port translation (NAPT) firewall 18 which may be serving the Internet telephony device 14.

The messaging system 10 comprises a session key management server 44, at least one application server 11, and at least one Internet telephony device 14.

In the exemplary embodiment, the session key management server 44 and each application server 11 are coupled directly to the Internet 12 (or to an ISP network that assigns each such device a globally routable IP address). This structure is represented because such structure would be a common implementation, but it is possible for the session key management server 44 and/or the application server 11 to be located on a subnet so long as connectivity as required for implementation of the present invention is maintained by way of firewall configuration or other means for providing network connectivity to devices located behind firewalls.

In the exemplary embodiment, the Internet telephony device 14 is coupled to a local area network (LAN) 16. Each device coupled to the LAN 16, including the Internet telephony device 14, is assigned an Internet IP address from a class of addresses reserved for private networks (e.g. a Private Network IP Address). The Private Network IP address is not globally unique, is not routable on the Internet 12, and is routable only on the LAN 16. The LAN 16 is coupled to the Internet 12 by a Network Address and Port Translation (NAPT) firewall 18.

The NAPT firewall 18 operates as an IP layer proxy and the IP frames exchanged between a device coupled to the LAN 16 (such as the Internet telephony device 14) and a device assigned a globally unique IP address (such as the session key management server 44 or the application server 11) are exchanged over TCP/IP connections and UDP/IP channels initiated by the Internet telephony device 14 to the session key management server 44 and application server 11 respectively.

For example, an Internet telephony device 14 served by an NAPT firewall 18 may initiate a secure TCP/IP connection using transport layer security to the session key management server 44 by addressing a TLS ClientHello IP frame to the globally unique IP address and a TCP port of the session key management server 44. The LAN 16 routes such frame to the NAPT firewall 18; the NAPT firewall 18 translating the source IP address and port number of such frame to the globally unique IP address of the NAPT firewall 18 and a TCP port number of the NAPT firewall 18 that associates with the frame; the NAPT firewall 18 stores a record of the translation in its translation tables such that a response frame from the session key management server 44 may be reverse translated and routed to the Internet telephony device 14; and the Internet 12 routes the frame to the session key management server 44.

As another example, the Internet telephony device 14 served by an NAPT firewall 18 may establish a UDP/IP channel to the application server 11 by addressing a UDP/IP frame to the globally unique IP address and UDP port of the application server 11. The LAN 16 routing such frame to the NAPT firewall 18; the NAPT firewall 18 translating the source IP address and port number of such frame to the globally unique IP address of the NAPT firewall 18 and a UDP port number of the NAPT firewall 18 that associates with the frame; the NAPT firewall 18 stores a record of the translation in its translation tables such that a response frame from the application server 11 may be reverse translated and routed to the Internet telephony device 14; and the Internet 12 routes the frame to the application server 11.

This architecture wherein the Internet telephony device 14 initiates the TCP/IP connection to the session key management server 44 (and the UDP/IP channel to the application server 11) enables the session key management server 44 (and the application server 11) to communicate back to the Internet telephony device 14 over such connection or channel even when the Internet telephony device 14 is coupled to a LAN 16 and served by an NAPT firewall 18.

In general, the session key management server 44 and each Internet telephony device 14 negotiate a unique device session master key 34. The device session master key 34 is provided to each application server 11 and then used to symmetrically encrypt only the payload of UDP/IP frames exchanged between the Internet telephony device 14 and each application server 11. By encrypting only the payload, the header of each UDP/IP frame remains unencrypted and may be translated by the NAPT firewall 18 without compromising the integrity of the frame routing or the encrypted payload.

Each Internet telephony device 14 is assigned: i) a globally unique identification number 64 (e.g. the IDT ID number 64) such as the MAC address of the Internet telephony device 14 or a unique number derived from the MAC address of the Internet telephony device 14; and ii) a key management contact 68. The key management contact 68 is configurable and may include a fully qualified domain name or an IP address and port number of the session key management server 44. Further, if digital certificates are used for authentication, the Internet telephony device 14 will also be assigned a digital certificate 66 which is digitally signed by a trusted certificate authority.

The Internet telephony device 14 uses the key management contact 68 to contact the session key management server 44 and negotiate the device session master key 34.

After negotiation of the device session master key 34 with the Internet telephony device 14, the session key management server 44 provides the device session master key 34 to each application server 11. More specifically, each application server 11: i) contacts the session key management server 44 to authenticate and negotiate an application server master key 36 for use encrypting/decrypting subscribe and notify messages exchanged between the session key management server 44 and the application server 11; and ii) subscribes to a notification services application 51 of the session key management server 44 to receive the device session master key 34 for each Internet telephony device 14 that is to use the services of the application server 11.

The notification services application 51 in general operates in accordance with known subscribe/notify protocols with the exception that each data frame is encrypted using the application session master key 36.

After the device session master key 34 is negotiated with an Internet telephony device 14 and provided to a subscribing application server 11, UDP/IP communications between the Internet telephony device 14 and the application server 11 are sent over a UDP/IP channel 32 (established by the Internet telephony device 14 to the application server 11 to assure NAPT firewall traversal) that is secured by encrypting the payload of each UDP/IP frames using a predetermined symmetric encryption algorithm and the device session master key 34. The UDP/IP channel 32 is therefore referred to a secure messaging channel 32.

Internet Telephony Device

Internet telephony device 14 includes, an IP module 58, network interface circuits 56, a system client 54, a PSTN interface module 82, a non-volatile memory 52, a volatile memory 70.

The network interface module 56 couples the Internet telephony device 14 to the LAN 16 and utilizes known networking protocols which are compliant with those utilized on the LAN 16 such that IP frames may be exchanged between the Internet telephony device 14 and other IP compliant devices over the LAN 16 and the Internet 12.

The IP module 58 formats application level data packets into TCP/IP or UDP/IP frames for transmission to remote application level systems of other network devices such as the session key management server 44 and the application servers 11.

In general, the Internet telephony device 14 functions, under the control of the system client 54, as VoIP gateway for a plurality of PSTN devices 94.

In more detail, the system client 54 interfaces with the PSTN interface module 82, the session key management server 44, and each application server 11 (using secure UDP/IP channels 32) to obtain Internet telephony services from the application servers 11 and drive the PSTN interface module 82 to generate analog and/or digital PSTN signals for providing corresponding telephony service to a plurality of PSTN devices 94.

For purposes of interfacing with the session key management server 44 and for securing UDP/IP communications with the application servers 11, the system client 54 includes a session key client 76 and an encryption engine 78.

The session key client 76 periodically contacts the session key management server 44 to authenticate and negotiate the device session master key 34—or opens and maintains a TLS connection with the session key management server 44 through which mutual authenticate occurs and through which the device session master key 34 is negotiated and periodically updated.

The encryption engine 78 performs the encryption/decryption of the payload of the UDP/IP messages exchanged with the application servers 11. More specifically, upon receipt of an inbound frame from an application server 11, the encryption engine 78 uses the device session master key 34 to decipher the encrypted payload of the frame to recover a message and then forwards the message to the telephony service provider client 80. Upon receipt of an outbound frame generated by the telephony service provider client 80 and addressed to an application server 11, the encryption engine 78 uses the device session master key 34 to encrypt only the payload portion of the frame and then forwards the frame on the network for routing to the application server 11.

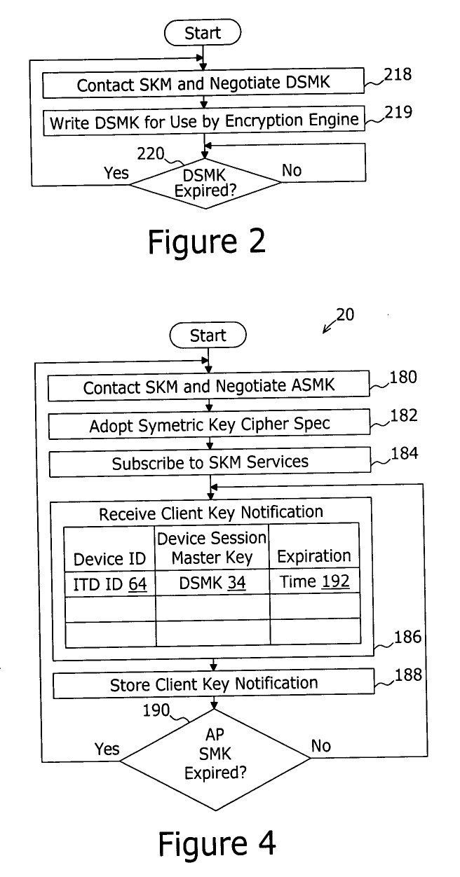

The flow chart of FIG. 2 represents exemplary operation of the session key client 76. With reference to FIG. 2 in conjunction with FIG. 1, step 218 represents establishing the TLS connection to the session key management server 44 for purposes of negotiating the device session master key 34.

Step 219 represents providing the device session master key 34 to the encryption engine 78 such that the encryption engine 78 may use the device session master key 34 in combination with a predetermined symmetric encryption algorithm for encrypting/decrypting the payload of UDP/IP frames exchanged between the Internet telephony device 14 and the application server 11.

The device session master key 34 has a predetermined life and will expire a predetermined time period following its calculation. After expiration, the session key client 76 will, as represented by decision box 220: i) “loop back” to step 218 if the TLS connection has been closed such that a new TLS connection is opened and a new device session master key 34 is negotiated; or ii) negotiate a new device session master key 34 through the existing TLS connection if not closed.

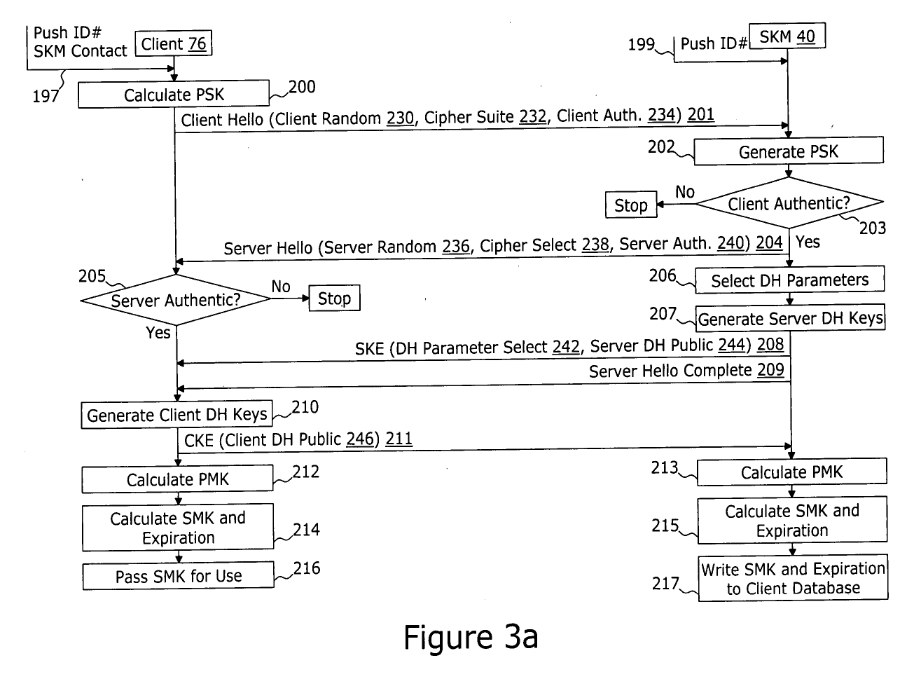

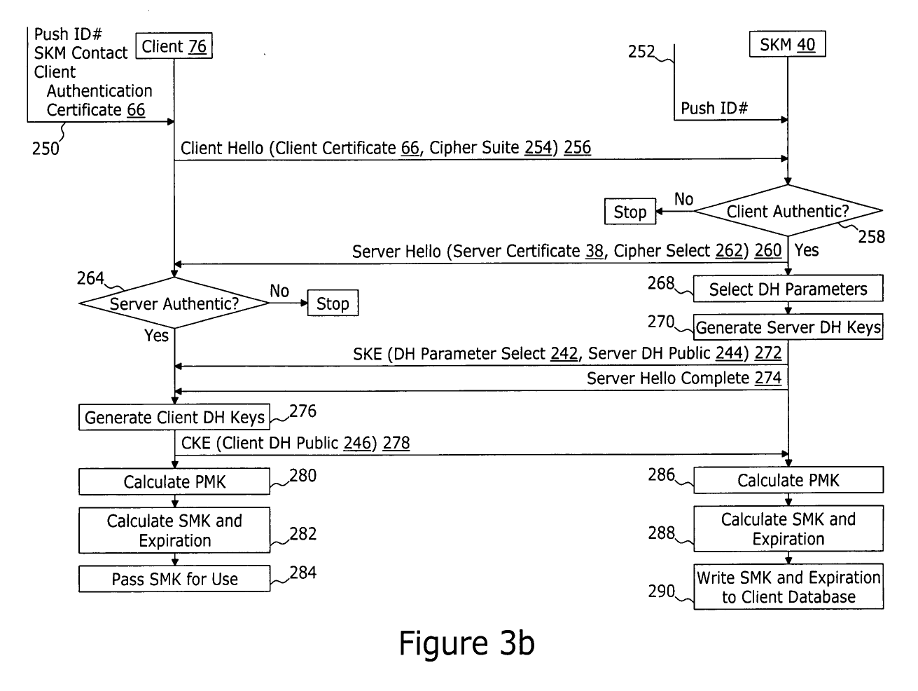

The ladder diagram of FIG. 3a represents the process of the session key client 76 and the session key management server 44 (or more particularly a key management application 40 of the session key management server 44) negotiating a device session master key 34 and its expiration time in an embodiment wherein mutual authentication occurs suing a pre-shared key algorithm.

Referring to the ladder diagram of FIG. 3 in conjunction with FIG. 1, when an Internet telephony device 14 is manufactured, it is assigned a unique ID number 64 (for example the MAC address of its communication circuits or a unique value derived from the MAC address). The unique ID number 64 and the key management contact 68 are stored in non-volatile memory 52 of the Internet telephony device 14. Such storage is represented by step 197.

The IDT ID number 64 is also provided to the session key management server 44 and written to a record of a session key database 42 of the session key management server as represented by step 199. The IDT ID number 64 may be provided to the session key management server 44 by a manufacturing facility if it is known at the time of manufacture that the Internet telephony device 14 is to be serviced by the application servers 11 associated with the session key management server 44. Alternatively, the client ID number 64 may be provided to the session key management server 44 by a point of sale facility if it is not known at the time of manufacture (but known at the time the Internet telephony device 14 is sold to a retail customer) that the Internet telephony device 14 is to be serviced by the systems associated with the session key management server 44.

Step 200 represents the session key client 76 calculating a pre-shared key. In the exemplary embodiment, the pre shared key is calculated using a predetermined algorithm and the unique IDT ID number 64 (e.g. the MAC address or a unique value derived from the MAC address) of the device on which the client 76 is installed.

Step 201 represents the session key client 76 generating a known TLS ClientHello message with extensions which include a client random value 230, a cipher suite 232, and a client authentication value 234.

The client random value 230 is a random number generated by the session key client 76. The cipher suite 232 is an identification of cipher protocols available to the session key client 76 which may be used for encrypting data. The client authentication value 234 is a hash of the IDT ID number 64 and the client random value 230. The hash may be an MD5 hash and is performed using the pre-shared key.

Step 202 represents the session key application 40 generating the pre-shared key using the IDT ID number 64 of the client (for example the MAC address from the header of the ClientHello) and the predetermined algorithm.

Step 203 represents the session key application authenticating the client by performing a hash of the IDT ID number 64 and the client random value 230 using the pre-shared key to determine whether such locally calculated client authentication value matches the client authentication value 234 provided by the client 76. If there is no match, the key management application 40 terminates.

If the client is authenticated, a known TLS ServerHello is provided to the client 76 at step 204—with extensions which include a server random value 236, a cipher select indication 238, and a server authentication value 240.

The server random value 236 is a random value generated by the key management application 40. The cipher select indication 238 is an indication of one of the cipher protocols from the cipher suite 232. The server authentication value 240 is a hash, using the pre-shared key, of both the client random value 230 and the server random value 236.

Step 205 represents the client 76 authenticating the session key management server 44 by performing the hash, using the pre-shared key, of the client random value 230 which was provided to the session key management server 44 and the server random value 236 to determine whether such locally calculated server authentication value matches the server authentication value 240 provided by the key management application 40. If there is no match, the client 76 terminates.

The key management application 40 also selects, at step 206, one of a plurality of pre-shared Diffie-Helman (DH) domain parameters to use for calculating a DH shared secret key. The DH domain parameters comprise a set of values commonly known as a prime value (P), a generator value (G), and a factor value (F).

Using the selected DH domain parameters, the key management application 40 calculates a DH public key and a DH private key using known DH algorithms at step 207.

At step 208 the key management application 40 provides a server key exchange message to the client 76. The server key exchange message is not a typical TLS message, but is added for purposes of implementing the present invention. The server key exchange message includes an indication of the set of DH domain parameters selected by the key management application 40 (e.g. DH parameters select 242) and the server DH public key 244.

Step 209 represents the key management application 40 providing a TLS ServerHello complete message.

Step 210 represents the client 76 generating a client DH private key and a client DH public key using known DH algorithms and the set of DH domain parameters indicated by the key management application 40.

At step 211, the client 76 provides a client key exchange message to the key management application 40. The client key exchange message is not a typical TLS message, but is added for purposes of implementing the present invention. The client key exchange message includes the client DH public key 246.

Step 212 represents the client 76 calculating a pre-master key which is a DH shared secret key calculated from the DH domain parameters, the client DH private key, and the server DH public key using known DH algorithms. Similarly, at step 213, the key management application 40 calculates the same pre-master key using the DH domain parameters, the server DH private key, and the client DH public key.

Step 214 represents the client 76 calculating the session master key 34. In the exemplary embodiment, the session master key 34 is calculated by performing an exclusive OR (XOR) on a combination of the pre-master key and the pre-shared key. Similarly, at step 215, the key management application 40 calculates the session master key 34.

At step 216 the client 76 passes the session master key 34 to the encryption engine 78 for use by the encryption engine 78 in exchanging UDP/IP messages with each application server 11.

Step 217 represents the key management application 40 writing the session master key 34 and its expiration time to the session key client database 42.

FIG. 3b represents an alternative process of the session key client 76 and the session key management server 44 (or more particularly a key management application 40 of the session key management server 44) negotiating a device session master key 34 and its expiration time in an embodiment wherein the exchange of digital certificates may be used for authenticating each of the Internet telephony device 14, the session key management server 44, and the application server 11.

In this embodiment, each of the Internet telephony device 14, session key management server 44 and application server 11 is assigned a digital certificate 66, 38, and 39 respectively (FIG. 1). Each digital authentication certificate may be a known digital certificate that is digitally signed by a trusted certificate authority (for example an X.509 compliant certificate) such that when the certificate (along with its certificate chain) is presented to another device (with access to the public key of the trusted certificate authority), the certificate identifies and authenticates the device presenting the certificate.

Referring to FIG. 3b in conjunction with FIG. 1, when an Internet telephony device 14 is manufactured, its unique ID number 64, the key management contact 68, and the authentication certificate 66 are stored in non-volatile memory 52 of the Internet telephony device 14. Such storage is represented by step 250.

The unique ID number 64 is also provided to the session key management server 44 and written to a record of a session key database 42 of the session key management server as represented by step 252.

Step 256 represents the session key client 76 generating a known TLS ClientHello message with extensions which include the client certificate 66 and a cipher suite 254. The cipher suite 232 is an identification of cipher protocols available to the session key client 76 which may be used for encrypting data.

Step 258 represents the session key application authenticating the client by performing by using the public encryption key of the trusted certificate authority to decrypt the digital signature of the client certificate 66. If the client certificate 66 does not authenticate the Internet telephony device 14, the key management application 40 terminates.

If the Internet telephony device 14 is authenticated, a known TLS ServerHello is provided to the client 76 at step 260—with extensions which include the server's digital certificate 38 and a cipher select indication 262, and a server authentication value 240. The cipher select indication 238 is an indication of one of the cipher protocols from the cipher suite 232.

Step 264 represents the client 76 authenticating the session key management server 44 by using the public encryption key of the trusted certificate authority to decrypt the digital signature of the server certificate 38. If the server certificate 38 does not authenticate the session key management server 44, the Internet telephony device 14 terminates the exchange.

In this embodiment, like the embodiment of FIG. 3, the key management application 40 also selects, at step 268, one of a plurality of pre-shared Diffie-Helman (DH) domain parameters to use for calculating a DH shared secret key. The DH domain parameters comprise a set of values commonly known as a prime value (P), a generator value (G), and a factor value (F).

Using the selected DH domain parameters, the key management application 40 calculates a DH public key and a DH private key using known DH algorithms at step 270.

At step 272 the key management application 40 provides a server key exchange message to the client 76. The server key exchange message is not a typical TLS message, but is added for purposes of implementing the present invention. The server key exchange message includes an indication of the set of DH domain parameters selected by the key management application 40 (e.g. DH parameters select 242) and the server DH public key 244.

Step 274 represents the key management application 40 providing a TLS ServerHello complete message.

Step 276 represents the client 76 generating a client DH private key and a client DH public key using known DH algorithms and the set of DH domain parameters indicated by the key management application 40.

At step 278, the client 76 provides a client key exchange message to the key management application 40. The client key exchange message is not a typical TLS message, but is added for purposes of implementing the present invention. The client key exchange message includes the client DH public key 246.

Step 280 represents the client 76 calculating a pre-master key which is a DH shared secret key calculated from the DH domain parameters, the client DH private key, and the server DH public key using known DH algorithms. Similarly, at step 286, the key management application 40 calculates the same pre-master key using the DH domain parameters, the server DH private key, and the client DH public key.

Step 282 represents the client 76 calculating the session master key 34. In the exemplary embodiment, the session master key 34 is calculated by performing an exclusive OR (XOR) on a combination of the pre-master key and the pre-shared key. Similarly, at step 288, the key management application 40 calculates the session master key 34.

At step 284 the client 76 passes the session master key 34 to the encryption engine 78 for use by the encryption engine 78 in exchanging UDP/IP messages with each application server 11.

Step 290 represents the key management application 40 writing the session master key 34 and its expiration time to the session key client database 42.

PSTN Interface Module

Returning to FIG. 1, the PSTN interface module 82 includes a PSTN driver 90, an audio DSP 88, and a Real Time Protocol (RTP) module 86.

The PSTN driver 90 is coupled to the audio DSP 88, and under control of the audio DSP 88, provides the PSTN analog and/or PSTN digital signals which emulate a PSTN subscriber loop on each PSTN port for interfacing with traditional PSTN devices 94.

The audio DSP 88 interfaces with both the RTP module 86 and a telephony service provider client 80 (e.g. a MGCP gateway) of the system client 54.

More specifically, when interfacing with the RTP module 86, the audio DSP 88 operates algorithms which convert between the digital audio media exchanged with the PSTN driver 90 and compressed digital audio media exchanged with the real time protocol implementation module 86 utilizing a compression algorithm stored as firmware of the audio DSP 88.

The real time protocol implementation module 86 operates during a media session to: i) encapsulate compressed digital audio media generated by the audio DSP 88 into real time protocol frames for transmission to a remote endpoint during a media session; and ii) receives and sequences real time protocol frames received from the remote endpoint and presents the compressed digital audio media encapsulated therein to the audio DSP 88.

When interfacing with the service provider client 80, the audio DSP 88 converts convert between digital in band signaling exchanged with the PSTN driver 90 and digital signals exchanged with the service provider client 80. More specifically, the audio DSP 88: i) detects PSTN events on each PSTN port (through the PSTN driver 90) such as Off Hook, On Hook, Flash Hook, DTMF tones, Fax Tones, TTD tones and generates applicable signaling signals to the client 80; and ii) generates PSTN signaling (through the PSTN driver 90) such as Ring, Dial Tone, Confirmation Tone, and in band caller ID in response to applicable signaling signals from the client 80.

The telephony service provider client 80 may be implemented as an MGCP Gateway. The telephony service provider client 80 communicates with the various application servers 11 as needed to operate as a VoIP endpoint within the Internet telephony service provider's infrastructure 19. More specifically, the telephony service provider client 76 may use UDP/IP messaging to application servers 11 such as TFTP provisioning servers, SYSLOG servers, and MGCP Call Agents for obtaining class and device configuration parameters, obtaining software and firmware version updates, messaging for system management, and messaging to set up and tear down peer to peer VoIP media sessions wit other Internet telephony devices.

Application Server

Returning to FIG. 1, the application server 11 comprises a session key client 76, a subscriber/notify client 23, an encryption engine 22, a session key database 26, and a UDP/IP application 24. In the exemplary embodiment, the UDP/IP application 24 may be an MGCP call agent application which exchanges UDP/IP messages with a plurality of Internet telephony device 14 (each operating an MGCP gateway) to facilitate the set up of peer to peer Internet telephony media sessions between each Internet telephony device 14 and other MGCP gateways.

However, it is recognized that an application service provider may have infrastructure that includes various other servers which typically exchange messages with clients using UDP/IP protocol. The UDP/IP application 24 may be any of such other servers including, but not limited to, an element management server (EMS) 26, a TFTP Server 28, and a CCCM Relay server 30, a SNMP management server, a SYSLOG server and other servers useful for managing and providing VoIP services to clients 14.

In general, the session key client 76 operates in the same manner as the session key client 76 of the Internet telephony device 14. The session key client 76 of the application server 11 contacts the session key management server 44 and negotiates the application session master key 36 with the session key management server 44 in the same manner as discussed with respect to the ladder diagram of FIG. 3.

Of course, when the session key client 76 is part of an application server 11: i) the MAC address of the application server 11 is used in place of the ITD ID number 64 for calculating the pre shared key; and ii) the session key client 76 passes the application session master key 36 to the encryption engine 22 of the application server 11.

The encryption engine 22: i) uses the application session master key 36 to encrypt/decrypt the messages exchanged between the subscribe/notify client 23 and the notification services application 51 of the session key management server 44; and ii) uses the device session master key 34 which corresponds to a particular Internet telephony device 14 to encrypt/decrypt messages exchanged between the UDP/IP application 24 and the system client 54 of the Internet telephony device 14 through the secure messaging channel 32.

The subscribe/notify client 23 exchanges messages with a notification services application 51 of the session key management server 44 to obtain the device session master key 34 (and its associated expiration time 72) for each Internet telephony device 14 that will obtain services from the application server 11. The flow chart of FIG. 4 represents exemplary operation of the subscriber/notify client 23 and its interaction with various components.

With reference to FIG. 4 in conjunction with FIG. 1, step 180 represents invoking the functions of the session key client 76 (as discussed with respect to the ladder diagrams of FIGS. 3a and 3b) to contact the session key management server 44 and negotiate an application session master key 36.

Step 182 represents providing the application session master key 36 to the encryption engine 22 such that the encryption engine 22 may adopt a negotiated symmetric key cipher specification (which operates with the application session master key 36) for use encrypting data exchanged between the application server 11 with the session key management server 44.

Step 184 represents the subscribe/notify client 23 subscribing to the notification services application 51 of the session key management server 44. All messages exchanged between the subscribe/notify client 23 and the notification services application 51 are encrypted using the negotiated symmetric encryption algorithm and the application session master key 36.

After subscribing to the notification services application 51, the notification services application 51 will provide a device session master key 34 (in conjunction with its expiration time 192) for each Internet telephony device 14 that is to receive services from the application server 11. Step 186 represents receiving such information Step 188 represents storing, in the session key database 26, each device session master key 34 and its expiration time 192 in conjunction with the IDT ID 64 of the Internet telephony device 14.

As discussed, each session master key (including the application session master key 36) includes an expiration time. Step 190 represents determining whether the application session master key 36 has expired. If not expired, the subscribe/notify client 23 may continue to receive notification messages (containing device session master keys 34) from the session master key server 44 using the application session master key 36 as represented by the “loop back” to step 186.

When the application session master key 36 expires, the session key client 76 again negotiates an application session master key 36 (e.g. a new application server session master key) by: i) looping back to step 180 and establishing a TLS connection if the TLS connection has been closed; or ii) negotiating a new application session master key 36 through the existing TLS connection if not closed.

The session key database 26 includes a plurality of records, each of which includes a ID field 28, a device session master key field 30, an expiration field, and a response socket field 31. The ID field 28 stores the unique identifier 64 of an Internet telephony device 14 that is to use the services of the application server 11. The session key field 30 stores the device session master key 34 negotiated between the Internet telephony device 14 and the session master key server 44. The expiration field stores the expiration time of the device session master key. The response socket field 31 stores the source IP address and source port number of the most recent UDP/IP frame received from the Internet telephony device 14 so that a response frame may be reverse addressed to assure traversal of the NAPT firewall 18.

When an inbound frame is received, the encryption engine 22 is able to extract the globally unique ID number of the Internet telephony device 14 from the header of the UDP/IP frame and look up the appropriate device session master key 34 to decipher the payload from the session key database 26 by locating the appropriate record using the ID number from the header.

When an outbound frame is received, the encryption engine 22 is able to look up, in the session key database 26, the appropriate device session master key 34 to encrypt the payload by locating the record that includes a response IP address and socket that matches the destination IP address and socket assigned to the outbound frame by the application 24.

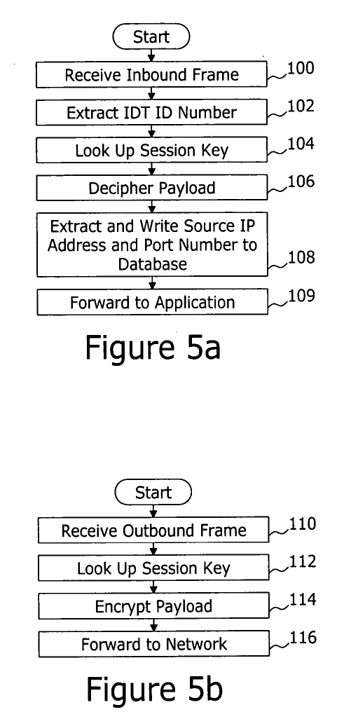

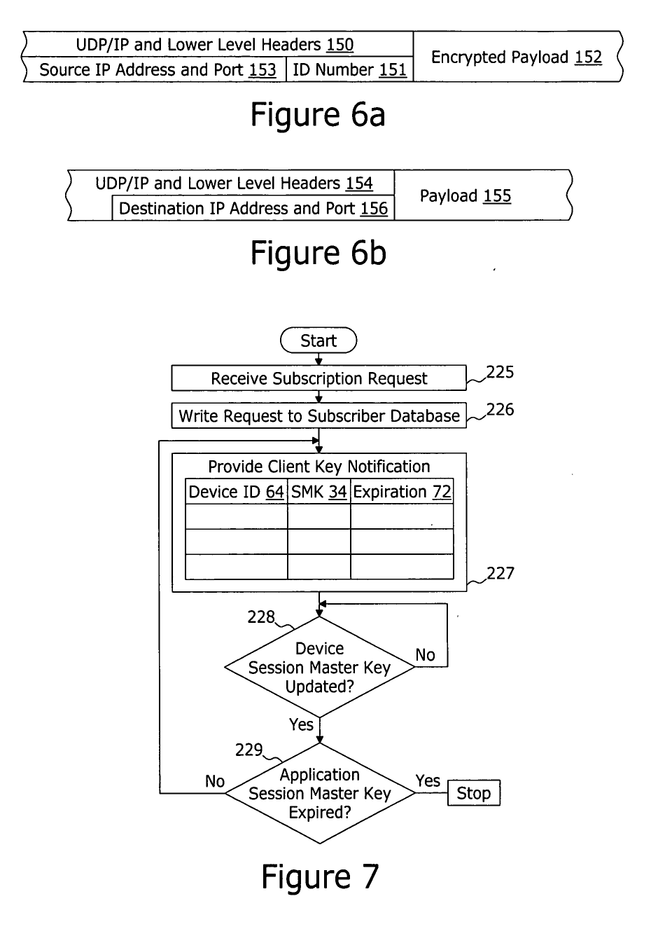

FIG. 5a includes a flow chart representing exemplary operation of the encryption engine 22 upon receipt of an inbound frame. FIG. 6a includes a diagram representing an inbound frame. Referring to FIG. 5a in conjunction with FIG. 6a and FIG. 1, the inbound frame includes UDP/IP headers 150 and payload 152 which has been encrypted by the Internet telephony device 14 using the predetermined symmetric encryption algorithm and the device session master key 36.

Included within the header 150 is a globally unique ID number 154 identifying the Internet telephony device 14. As discussed, in the exemplary embodiment this globally unique identifier 154 may be the MAC address of the network interface module of the Internet telephony device 14 such that its inclusion in the header 150 is part of standard UDP/IP protocols.

Step 100 represent receipt of the inbound frame from an Internet telephony device 14; step 102 represents extraction of the unique ID number 154 from the frame header 150 and step 104 represents looking up the device session master key 34 which associates with the ID number within the session key database 26.

Step 106 represents using the predetermined symmetric encryption algorithm and the device session master key 34 to decipher the encrypted payload 152 and recover the MGCP message included therein.

Step 108 represents extracting the source IP address and port number from the inbound frame and writing those values to the response socket field 31 of the record of the database 26 that associated with the Internet telephony device 14 (this enables the encryption engine to locate the device session master key 34 to use to encrypt payload of an outbound frame).

Step 109 represent forwarding the frame (or the MGCP message) to the application 24.

FIG. 5b includes a flow chart representing exemplary operation of the encryption engine 22 upon receipt of an outbound frame. FIG. 6b includes a diagram representing an outbound frame. Referring to FIG. 5b in conjunction with FIG. 6b and FIG. 1, the outbound frame includes UDP/IP headers 154 and payload 155. Within the headers 154 are a destination IP address and port number 156 which associate with the UDP/IP channel 32.

Step 110 represent receipt of an outbound frame from the application 24, step 112 represents looking up the device session master key 34 which associates with the destination IP address and port number 156 read from the header 154, step 114 represents encrypting the payload 155 of the frame using the predetermined symmetric encryption algorithm and the device session master key 34, and step 116 represents forwarding the UDP/IP message to the network 12 for routing to the Internet telephony device 14 (or routing the NAPT firewall 18 serving the Internet telephony device 14 and subsequent routing over the LAN 16 to the Internet telephony device 14).

Session Key Management Server

The session key management server 44 includes a session key management application 40, a session key database 42, a notification services application 51.

The key management application 40 negotiates (as discussed with respect to the ladder diagrams of FIGS. 3a and 3b): i) a device session master key 34 with each Internet telephony device 14 which contacts the session key management server 44 for purposes of negotiating a device session master key 34; and ii) writes the device session master key 34 along with its expiration 72 and the IDT ID number 64 of the Internet telephony device 14 to the session key database 42.

The key management application 40 also negotiates (as discussed with respect to the ladder diagrams of FIGS. 3a and 3b): i) an application session master key 36 with each application server 11 which contacts the session key management server 44 for purposes of negotiating an application session master key 36 and subscribing to the notification services application 51.

Notification Services Application

The flow chart of FIG. 7 represents exemplary operation of the notification services application 51. Referring to FIG. 7 in conjunction with FIG. 1, step 225 represents receipt of a subscription request from a subscribe/notify client 23 of a of an application server 11. The subscription request may be delivered to the session key management server 44 as a UDP/IP message with its payload encrypted using the application session master key 36 negotiated between the key management application 40 and the session key client 76 of the application server 11. The encryption engine 22 deciphers the encrypted payload for delivery of the message to the notification services application 51.

Step 226 represents writing the subscription request to the session key client database 42. More specifically, an indication of the application server 11 may be added to a notification field 50 of each record associated with an Internet telephony device 14 which receives services form the application server 11.

Step 227 represents providing to the subscribe/notify client 23 a notification message. The notification message is encrypted using the application session master key 36 and includes a device session master key 34 (in conjunction with its expiration time 72) for each internet telephony device 14 that is to receive services from the application server 11. Such information is obtained from the session key client database 42.

As discussed, each device session master key 34 and each application session master key 36 has a limited life. When a device session master key 34 is updated, then so long as the application session master key 36 has not expired, a new notification message will be sent to the subscriber/notify client 23. If the session master key 36 has expired, a notification message will not be sent. However, as discussed with respect to FIG. 4, the session key client 76 of the application server 11 is configured to automatically negotiate a new application session master key 36 upon its expiry. Therefore, in normal operation, the application session master key 36 will never be “expired” and prevent delivery of notification massages to the subscribe notify client 23.

Although the invention has been shown and described with respect to certain preferred embodiments, it is obvious that equivalents and modifications will occur to others skilled in the art upon the reading and understanding of the specification.

For example, in the exemplary embodiment, the session key management connection 34 may be a TLS connection over hypertext transport protocol (e.g. an HTTPS connection). However, it is envisioned that other systems that include authentication by the exchange of digital certificates for mutual authentication and secure communication using either: i) the exchange of data using asymmetric encryption and public/private key pairs; or ii) the exchange of data using symmetric encryption and a symmetric encryption key that is generated by mutual (but independent) calculation using exchanged public key generator values, each a public key generator value of a public/private key generator value pair. The present invention includes all such equivalents and modifications, and is limited only by the scope of the following claims.

What is claimed is:

1. A session key management server for securing communications between a client and an application server, the session key management server comprising:
a key management application for:
receiving a first transport layer security connection request from the client;
negotiating a device session master key with the client as part of the transport layer security exchange;
a session key database coupled to the key management application for storing the device session master key in conjunction with an identification of the client; and
a notification services application coupled to the session key database for providing a notification message to the application server, the notification message comprising the device session master key in conjunction with an identification of the client.

2. The session key management server of claim 1, wherein:
the key management application further provides for:
receiving an application transport layer security connection request from the application server;
negotiating an application session master key with the application server as part of the transport layer security exchange; and
the session key management server further comprises an encryption engine, the encryption engine using the application session master key to encrypt the notification message before provision to the application server.

3. The session key management server of claim 1, wherein:
the key management application further calculates an expiration time for the device session master key;
the database further stores the expiration time in conjunction with the device session master key;
the notification message further comprises the expiration time of the device session master key; and
the notification server further provides an updated notification message to the application server, the updated notification message comprising an updated device session master key and an updated expiration time in replacement of an expired device session master key.

4. The session key management server of claim 3, wherein:
the key management application further provides for:
receiving an application transport layer security connection request from the application server;
negotiating an application session master key with the application server as part of the transport layer security exchange; and
the session key management server further comprises an encryption engine, the encryption engine using the application session master key to encrypt each of the notification message and the updated notification message before provision to the application server.

5. The session key management server of claim 3, wherein:
the session key management application further:
receives a second transport layer security connection request from a second client;
negotiating a second device session master key with the second client as part of the transport layer security exchange;
calculating an expiration time for the second device session master key;
the session key database further stores the second device session master key and its expiration time in conjunction with an identification of the second client;
the notification message further comprises the second device session master key and its expiration time in conjunction with the identification of the second client; and the updated notification message further comprises an updated second device session master key and its updated expiration time in replacement of an expired second device session master key.

6. The session key management server of claim 5, wherein:
the key management application further provides for:
receiving an application transport layer security connection request from the application server;
negotiating an application session master key with the application server as part of the transport layer security exchange; and
the session key management server further comprises an encryption engine, the encryption engine using the application session master key to encrypt each of the notification message and the updated notification message before provision to the application server.

7. A system for securing communications between a client and an application server, the system comprising a session key management server and the application server:
the session key management server comprising:
a key management application for:
receiving a first transport layer security connection request from the client;
negotiating a device session master key with the client as part of the transport layer security exchange;
a session key database coupled to the key management application for storing the device session master key in conjunction with an identification of the client; and
a notification services application coupled to the session key database for providing notification message to the application server, the notification message comprising the device session master key in conjunction with an identification of the client;
the application server comprising:
a notification client for obtaining the notification message from the notification services application;
a database coupled to the notification client storing the device session master key in conjunction with identification of the client; and
an encryption module coupled to the database for:
receiving a message from the client, the message including the identification of the client in a message header and encrypted payload; and
obtaining the device session master key associated with the identification of the client from the database; and
deciphering the encrypted payload using a symmetric encryption algorithm and the device session master key to generated deciphered payload.

8. The system of claim 7, wherein:
the application server further comprises a base application coupled to the encryption module for:
receiving the deciphered payload and generating a response message for the client, the response message including response payload and a header, the header including a destination IP address and port number matching the source IP address and port number of the message header of the message; and
the encryption module further provides for encrypting the response payload of the response message using the symmetric encryption algorithm and the device session master key that is associated with the client that is associated with the destination IP address of the response message.

9. The system of claim 9, wherein:
the key management application further provides for:
receiving an application transport layer security connection request from the application server;
negotiating an application session master key with the application server as part of the transport layer security exchange; and
the session key management server further comprises an encryption engine, the encryption engine using the application session master key to encrypt the notification message before provision to the application server.

10. The system of claim of claim 8, wherein:
the key management application further calculates an expiration time for the device session master key;
the database further stores the expiration time in conjunction with the device session master key;
the notification message further comprises the expiration time of the device session master key; and
the notification server further provides an updated notification message to the application server, the updated notification message comprising an updated device session master key and an updated expiration time in replacement of an expired device session master key.

11. The system of claim of claim 10, wherein:
the key management application further provides for:
receiving an application transport layer security connection request from the application server;
negotiating an application session master key with the application server as part of the transport layer security exchange; and
the session key management server further comprises an encryption engine, the encryption engine using the application session master key to encrypt each of the notification message and the updated notification message before provision to the application server.

12. The system of claim of claim 10, wherein:
the key management application further:
receives a second transport layer security connection request from a second client;
negotiating a second device session master key with the second client as part of the transport layer security exchange;
calculating an expiration time for the second device session master key;
the session key database further stores the second device session master key and its expiration time in conjunction with an identification of the second client;
the notification message further comprises the second device session master key and its expiration time in conjunction with the identification of the second client; and
the updated notification message further comprises an updated second device session master key and its updated second expiration time in replacement of an expired second device session master key.

13. The system of claim of claim 12, wherein:
the key management application further provides for:
receiving an application transport layer security connection request from the application server;
negotiating an application session master key with the application server as part of the transport layer security exchange; and
the session key management server further comprises an encryption engine, the encryption engine using the application session master key to encrypt each of the notification message and the updated notification message before provision to the application server.

14. A method of operating a session key management server and an application server for securing communications between a client and the application server, the method comprising:
receiving a first transport layer security connection request from the client;
negotiating a device session master key with the client as part of the transport layer security exchange;
storing the device session master key in conjunction with an identification of the client in a session key database of the session key management server;
providing a notification message to the application server, the notification message comprising the device session master key in conjunction with an identification of the client;
storing, in a session key database of the application server, the device session master key in conjunction with an identification of the client;
receiving a message from the client, the message including the identification of the client in a message header and encrypted payload;
obtaining the device session master key associated with the identification of the client from the session key database; and
deciphering the encrypted payload using a symmetric encryption algorithm and the device session master key to generated deciphered payload.

15. The method of claim 14, further comprising
generating a response message for the client, the response message including response payload and a header, the header including a destination IP address and port number matching the source IP address and port number of the message header of the message; and
encrypting the response payload using the symmetric encryption algorithm and the session master key that is associated with the client that is associated with the destination IP address of the response message.

16. The method of claim 15, further comprising:
the application server sending an application transport layer security connection request to the session key management server;
negotiating an application session master key between the application server and the session key management server as part of the transport layer security exchange; and
using the application session master key to encrypt the notification message for provision to the application server.

17. The method of claim of claim 15, further comprising:
calculating an expiration time for the device session master key;
storing the expiration time in conjunction with the device session master key in the session key database of the session key management server;
including the expiration time of the device session master key in the notification message; and
providing an updated notification message to the application server, the updated notification message comprising an updated device session master key and an updated expiration time in replacement of an expired device session master key.

18. The method of claim of claim 17, further comprising:
the application server sending an application transport layer security connection request to the session key management server;
negotiating an application session master key between the application server and the session key management server as part of the transport layer security exchange; and
using the application session master key to encrypt each of the notification message and the updated notification message for provision to the application server.

19. The method of claim of claim 17:
further comprising:
receiving a second transport layer security connection request from a second client;
negotiating a second device session master key with the second client as part of the transport layer security exchange;
calculating an expiration time for the second device session master key;
storing the second device session master key and its expiration time in conjunction with an identification of the second client in the session key database of the session key management server;
the notification message further comprises the second device session master key and its expiration time in conjunction with the identification of the second client; and
the updated notification message further comprises an updated second device session master key and its updated expiration time in replacement of an expired second device session master key.

20. The method of claim of claim 19, further comprising:
the application server sending an application transport layer security connection request to the session key management server;
negotiating an application session master key between the application server and the session key management server as part of the transport layer security exchange; and
using the application session master key to encrypt the notification message and the updated notification message for provision to the application server.
